(19) United States
(12) Patent Application Publication
(10) Pub. No.: US 2024/0422496 A1
(43) Pub. Date: Dec. 19, 2024

(54) SOUND SIGNAL PROCESSING METHOD, SOUND SIGNAL PROCESSING DEVICE, AND SOUND SIGNAL DISTRIBUTION SYSTEM

(71) Applicant: Yamaha Corporation, Hamamatsu (JP)

(72) Inventor: Kenji ISHIZUKA, Hamamatsu (JP)

(21) Appl. No.: 18/821,581

(22) Filed: Aug. 30, 2024

Related U.S. Application Data
(63) Continuation of application No. PCT/JP2023/008467, filed on Mar. 7, 2023.

(30) Foreign Application Priority Data
Mar. 7, 2022 (JP) 2022-034141

(51) Int. Cl. H04S 7/00; G06F 3/16; H04S 3/00

(52) U.S. Cl. CPC H04S 7/301; G06F 3/165; H04S 3/008; H04S 2400/01

(57) ABSTRACT

A sound signal processing method includes receiving, from a distribution source, a sound signal, and a first parameter of a first signal processing to be applied to the sound signal, detecting a first acoustic characteristic of a listener's reproduction environment, adjusting a second parameter based on the first parameter and the first acoustic characteristic, and applying a second signal processing on the sound signal based on the second parameter, thereby obtaining a reproduction sound signal to be reproduced in the reproduction environment.

### CROSS-REFERENCE TO RELATED APPLICATIONS

This application is a continuation application of International Application No. PCT/JP2023/008467, filed on Mar. 7, 2023, which claims priority to Japanese Patent Application No. 2022-034141 filed in Japan on Mar. 7, 2022. The entire disclosures of International Application No. PCT/JP2023/008467 and Japanese Patent Application No. 2022-034141 are hereby incorporated herein by reference.

### BACKGROUND

### Technological Information

One embodiment of this disclosure relates to a sound signal processing method and a sound signal processing device that carry out prescribed signal processing on a sound signal.

### BACKGROUND TECHNOLOGY

Japanese Laid-Open Patent Publication No. H6-186966 discloses an effector that imparts a reverberation sound, such as that of Carnegie Hall, to a sound signal of an electronic instrument. The effector of Japanese Laid-Open Patent Publication No. H6-186966 adjusts effect parameters of a reverberation sound in accordance with the acoustics of a room.

### SUMMARY

When distributing sound signals as content, a distributor (operator on the distribution side) adds an effect, etc., to the sound signal to carry out sound production of the content to be distributed. Japanese Laid-Open Patent Publication No. H6-186966 does not anticipate distributing sound signals as content. The effector of Japanese Laid-Open Patent Publication No. H6-186966 does not consider parameters of the effect added to the content, so there may be cases where the distributor's intended effect cannot be realized.

In consideration of such circumstances, an object of one aspect of the present disclosure is to provide a sound signal processing method that can reproduce a distributor's intended effect on the listener's side at the time of reproduction.

A sound signal processing method according to one embodiment of this disclosure comprises receiving, from a distribution source, a sound signal, and a first parameter of a first signal processing to be applied to the sound signal, detecting a first acoustic characteristic of a listener's reproduction environment, adjusting a second parameter based on the first parameter and the first acoustic characteristic, and applying a second signal processing on the sound signal based on the second parameter, thereby obtaining a reproduction sound signal to be reproduced in the reproduction environment.

According to one embodiment of this disclosure, it is possible to reproduce an effect intended by a distributor during reproduction on the listener's side.

### BRIEF DESCRIPTION OF THE DRAWINGS

FIG. 1 is a block diagram showing a configuration of a sound signal processing system 1.

FIG. 2 is a block diagram showing main components of a sound signal processing device 10A.

FIG. 3 is a block diagram showing main components of a distribution device 10.

FIG. 4 is a flowchart showing an operation of the sound signal processing device 10A.

FIG. 5 A is a diagram showing, on a time axis, a first parameter of a reverb effect of a first signal processing intended by a distributor.

FIG. 5 B is a diagram showing, on a time axis, a first acoustic characteristic of a reproduction environment.

FIG. 5 C is a diagram showing, on a time axis, a second parameter of a second signal processing.

FIG. 6 is a flowchart showing an operation of the sound signal processing device 10A according to a first modified example.

FIG. 7 A is a diagram showing, on a time axis, a first parameter of a reverb effect of a first signal processing intended by a distributor.

FIG. 7 B is a diagram showing, on a time axis, a first acoustic characteristic of a reproduction environment.

FIG. 7 C is a diagram showing, on a time axis, a second acoustic characteristic of a distribution source.

FIG. 8 is a diagram showing, on a time axis, a second parameter of a second signal processing.

FIG. 9 A is a diagram showing, on a time axis, a first parameter of a reverb effect of a first signal processing intended by a distributor.

FIG. 9 B is a diagram showing, on a time axis, a target acoustic characteristic.

FIG. 9 C is a diagram showing, on a time axis, a first acoustic characteristic of a reproduction environment.

FIG. 10 is a diagram showing, on a time axis, a second parameter of a second signal processing.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

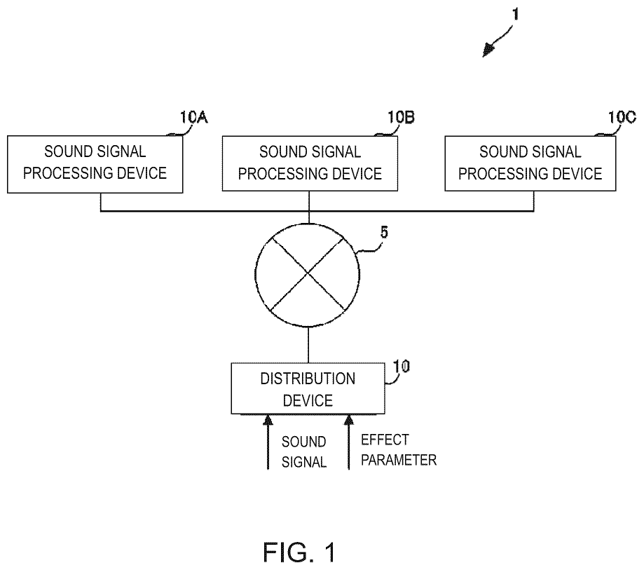

FIG. 1 is a block diagram showing a configuration of a sound signal processing system 1. The sound signal processing system 1 comprises a distribution device 10, a sound signal processing device 10A, a sound signal processing device 10B, and a sound signal processing device 10C. The sound signal processing device 10A, the sound signal processing device 10B, and the sound signal processing device 10C are respectively connected to the distribution device 10 via the Internet 5.

The sound signal processing device 10A, the sound signal processing device 10B, and the sound signal processing device 10C are each an information processing device, such as a personal computer. The distribution device 10 is also an information processing device, such as a personal computer.

The distribution device 10 is installed at a venue of a distribution source, in a location suitable for recording a performance, such as a studio. The sound signal processing device 10A, the sound signal processing device 10B, and the sound signal processing device 10C can be installed in a room in a home, or a rental room, different from a studio, where a remote user (listener) who listens to the content resides.

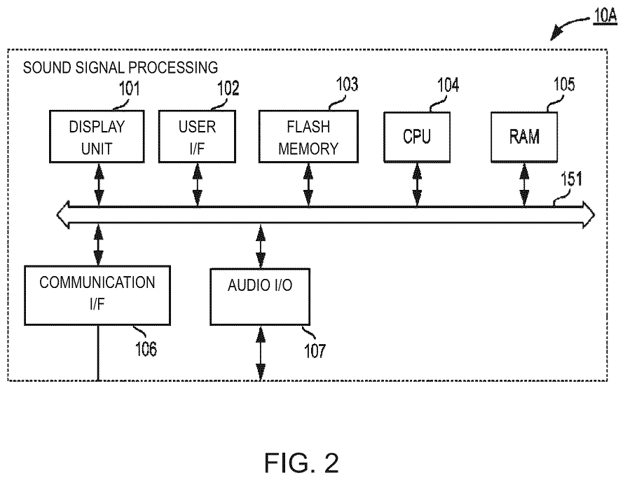

FIG. 2 is a block diagram showing main components of the sound signal processing device 10A. The configuration of the sound signal processing device 10A is shown in FIG. 2 as a representative example, but the sound signal processing device 10B and the sound signal processing device 10C also have the same configuration.

The sound signal processing device 10A includes a display unit 101, a user interface (I/F) 102, a flash memory 103, a CPU (Central Processing Unit) 104, a RAM (Random Access Memory) 105, a communication interface (I/F) 106, and an audio I/O 107. These components are connected via a bus 151.

The display unit (display) 101 includes a liquid crystal display (LCD) or an organic light-emitting diode (OLED), for example, and displays various information. The user I/F 102 is, for example, a user operable input, includes at least one or more of a switch, a keyboard, a mouse, a trackball, a touch panel, or the like, and receives user operations. If the user I/F 102 is a touch panel, the user I/F 102 constitutes a graphical user interface (GUI) together with the display unit 101.

The communication I/F 106 corresponds to the receiver of this disclosure, and is connected to the Internet 5 via a communication line, such as Ethernet (registered trademark). The sound signal processing device 10A receives content from the distribution device 10 via the communication I/F 106. The content distributed by the distribution device 10 can be received by a server (not shown).

The CPU 104 corresponds to the detector and the processor of this disclosure. The processor can be included in an electronic controller, and the electronic controller can be configured to comprise, instead of the CPU 104 or in addition to the CPU 104, an SPU (Sound Processing Unit), a DSP (Digital Signal Processor), an FPGA (Field Programmable Gate Array), an ASIC (Application Specific Integrated Circuit), and the like. The term “electronic controller” as used herein refers to hardware that executes software programs. The CPU 104 reads a program stored in the flash memory 103, which is a storage medium (computer memory), into the RAM 105, to thereby realize prescribed functions. For example, the CPU 104 displays an image for receiving user operations on the display unit 101, and receives a selection operation, etc., on the image via the user I/F 102, thereby realizing a GUI.

The CPU 104 reproduces the content received via the communication I/F 106. The CPU 104 outputs, to the audio I/O 107, a sound signal relating to the reproduced content. The audio I/O 107 is an interface for connecting audio devices (not shown), such as a speaker or a microphone. The audio I/O 107 outputs, to a speaker, a sound signal relating to the reproduced content. As a result, a user of the sound signal processing device 10A can listen to the sound of the content distributed from the distribution source.

It is not necessary for the program that is read by the CPU 104 to be stored in the flash memory 103 in the device itself. For example, the program can be stored on a storage medium of an external device, such as a server. In this case, the CPU 104 can read the program from the server into the RAM 105 to thereby execute the program each time.

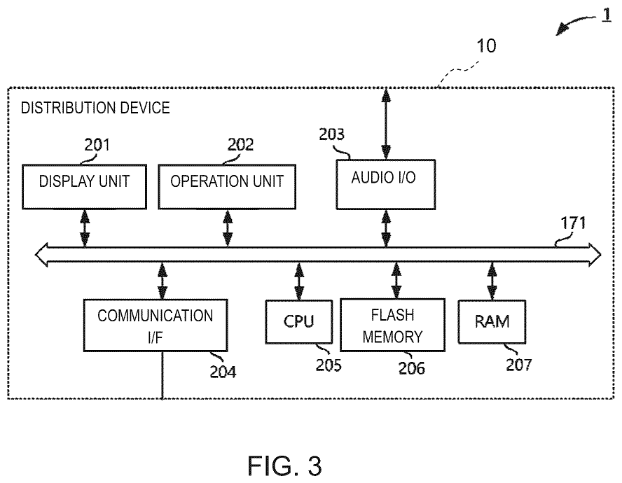

FIG. 3 is a block diagram showing the configuration of the distribution device 10. The distribution device 10 has a display unit 201, an operation unit 202, an audio I/O 203, a communication I/F 204, a CPU 205, a flash memory 206, and a RAM 207. These components are connected via a bus 171.

The display unit 201 (display) includes an LCD or an OLED and displays various information. The operation unit 202 is, for example, a user operable input, includes at least one or more a switch, a keyboard, a mouse, a trackball, a knob, a slider, a touch panel, or the like, and receives user operations. If the operation unit 202 is a touch panel, the operation unit 202 constitutes the GUI together with the display unit 201.

The CPU 205 is a control unit (electronic controller) that controls the operation of the distribution device 10. The control unit can be configured to comprise, instead of the CPU 205 or in addition to the CPU 205, an SPU (Sound Processing Unit), a DSP (Digital Signal Processor), an FPGA (Field Programmable Gate Array), an ASIC (Application Specific Integrated Circuit), and the like. The term “electronic controller” as used herein refers to hardware that executes software programs. The CPU 205 reads a prescribed program (sound signal processing program) stored in the flash memory 206, which is a storage medium (computer memory), into the RAM 207 and executes the program in order to perform various operations. The program can be stored in a sever. The CPU 205 can download the program from a server via a network and execute the program.

The audio I/O 203 is connected to a sound source, such as a microphone, a musical instrument, or a musical instrument amplifier. The audio I/O 203 receives a plurality of sound signals having, as the main components, the respective sounds of a plurality of sound sources.

The distributor (operator on the distribution side) sets, via the operation unit 202, a first parameter of a first signal processing to be applied to each of a plurality of sound signals input from these audio devices. The distributor adjusts, using a monitor, the first parameter while listening to the sound on which the first signal processing has been performed. The monitor can be any of headphones worn by the distributor, a speaker near the distributor, or a main speaker of a live music venue where the distributor resides.

For example, the first signal processing includes a process of adjusting the stereotactic position and the level of each sound signal, and a process of adding reverb. The first parameter is a parameter for controlling the first signal processing. The first parameter for controlling a reverb process includes parameters indicating the decay time and depth of the reverb. Sound sources, such as microphones, musical instruments, and musical instrument amplifiers are installed where there is little sound reflection, such as a studio. Therefore, the distributor adds a prescribed effect, such as a reverb effect, on a sound of a sound source, such as a microphone, a musical instrument, or a musical instrument amplifier, and carries out sound production (adjusts the first parameter) while checking, on a monitor, the sound to which the effect is applied. However, in the present embodiment, the distribution device 10 does not apply the first signal processing to the received sound signal, and distributes these plurality of sound signals and the first parameter of the first signal processing to be applied to these plurality of sound signals.

The distributor can set, via the operation unit 202, the first parameter of the first signal processing to be applied to the sound signal obtained after mixing the sound signals of a plurality of sound sources.

The CPU 205 receives a plurality of sound signals via the audio I/O 203. In addition, the CPU 205 receives the first parameter of each of the plurality of sound signals via the operation unit 202.

The CPU 205 adds the first parameter to each of the plurality of sound signals that have been received, and outputs the sound signals to the communication I/F 204 as content.

The communication I/F 204 connects to the Internet 5 via a communication line, such as Ethernet (registered trademark). The distribution device 10 distributes content via the communication I/F 106. The content can be distributed via a server (not shown).

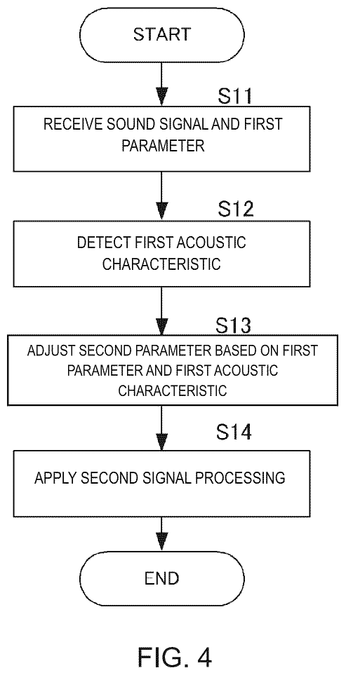

FIG. 4 is a flowchart showing an operation of the sound signal processing device 10A located in a listener's room. The receiver of the sound signal processing device 10A receives a plurality of sound signals from the distribution device 10 and the respective first parameters thereof (S11).

The detector of the sound signal processing device 10A detects the first acoustic characteristic indicating the reproduction environment of the room (S12). The sound signal processing device 10A outputs a test sound to the room from a speaker (not shown), for example, measures impulse response with a microphone (not shown), and acquires a first acoustic characteristic indicating the reproduction environment, such as the reverberation time and reverberation amount of that room. The first acoustic characteristic can be a characteristic for each frequency band.

The processor of the sound signal processing device 10A adjusts the second parameter of the second signal processing on the basis of the first parameter that has been received and the first acoustic characteristic that has been detected (S13). The processor of the sound signal processing device 10A further applies the second signal processing to the sound signal that has been received on the basis of the adjusted second parameter (S14). By applying the second signal processing on the sound signal based on the second parameter, a sound signal to be reproduced (reproduction sound signal) in the reproduction environment of the room is obtained.

The second signal processing includes the same type of reverb process for adding reverb to a sound signal as the process included in the first signal processing. The second parameter is a value obtained by correcting the first parameter with the first acoustic characteristic. The second parameter for controlling the reverb process includes the decay time and depth of the reverb.

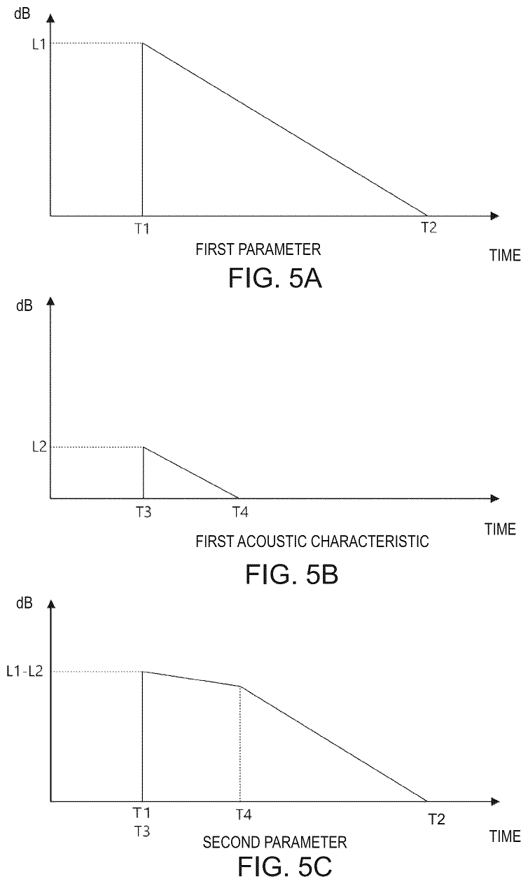

FIG. 5A is a diagram showing, as an envelope curve on a time axis, the reverb effect of the first signal processing intended by the distributor. FIG. 5B is a diagram showing the first acoustic characteristic of the reproduction environment as an envelope curve on the time axis. FIG. 5C is a diagram showing the reverb effect of the second signal processing as an envelope curve on the time axis. In FIGS. 5A-5C, the vertical axis represents the sound pressure (dB) of the impulse response, and the horizontal axis represents the time.

The processor of the sound signal processing device 10A calculates the impulse response of the reverb process from the first parameter, and calculates the envelope (FIG. 5A) of said impulse response. The processor of the sound signal processing device 10A measures the impulse response of the room, and calculates the envelope (FIG. 5B) of said impulse response. The processor of the sound signal processing device 10A subtracts the envelope (FIG. 5B) of the impulse response of the room from the envelope (FIG. 5A) of the impulse response calculated from the first parameter, to calculate the envelope (FIG. 5C) of the difference. The processor of the sound signal processing device 10A adjusts the second parameter such that the impulse response of the reverb process approximates the envelope (FIG. 5C) of this difference. The calculation of the difference of the impulse response can be carried out in the frequency domain. For example, as shown in FIG. 5A, the distributor has set a reverb effect in which the reverberation sound of level L1 gradually decays from time T1 to time T2. As shown in FIG. 5B, the reproduction environment displays an acoustic characteristic in which a reverberation sound of level L2 generated at time T3 (which coincides with time T1 in this example.) decays until time T4. In this case, the sound signal processing device 10A calculates a second parameter of the reverb effect obtained by subtracting (or dividing) the level of the reverberation sound generated in the reproduction environment from the first parameter of the first signal processing, from time T1 to time T4, as shown in FIG. 5C.

As a result, the sound signal processing device 10A is able to allow the listener to listen to a sound to which has been added an effect that is close to the distributor's intention.

If the sound signal is each of a plurality of sound signals corresponding to sounds from a plurality of sound sources, and the first parameter is each of a plurality of first parameters corresponding to the plurality of sound sources, the sound signal processing device 10A controls the second signal processing for each of the plurality of sound signals in accordance with the plurality of first parameters. That is, the sound signal processing device 10A calculates each second parameter on the basis of the respective first acoustic characteristic and the first parameter corresponding to the plurality of sound signals. The sound signal processing device 10A mixes, and outputs to the audio I/O 107, the plurality of sound signals after the second signal processing has been applied thereto. In the case that the content includes a sound signal obtained by mixing a plurality of sound signals and the first parameter of the first signal processing to be applied to the sound signal after mixing, the sound signal processing device 10A carries out the second signal processing on the sound signal after mixing.

### First Modified Example

In the step of receiving the second acoustic characteristic of the environment of the venue of the distribution source and adjusting the second parameter, the sound signal processing device 10A can adjust the second parameter on the basis of the first parameter that has been received, the second acoustic characteristic, and the first acoustic characteristic that has been detected.

In the embodiment described above, the environment of the venue of the distribution source is a studio with extremely little sound reflection, but the environment of the venue of the distribution source can be a live music venue, such as a concert hall. In this case, the distribution device 10 acquires the second acoustic characteristic of the audience seats of a live music venue. The second acoustic characteristic is a characteristic (impulse response) indicating the reproduction environment, such as the reverberation time and the reverberation amount of a live music venue. The first acoustic characteristic can be a characteristic for each frequency band. The distribution device 10 outputs a test sound from a speaker (not shown) in advance before a live event, collects the sound signal of the impulse response with a microphone (not shown), and calculates the second acoustic characteristic of the environment of the venue of the distribution source on the basis of the sound signal. Alternatively, the distribution device 10 can calculate the second acoustic characteristic of the environment of the venue of the distribution source as needed during a live event, on the basis of sound signals being reproduced by the speaker and sound signals collected from the audience seats. The distribution device 10 distributes the second acoustic characteristic that has been acquired.

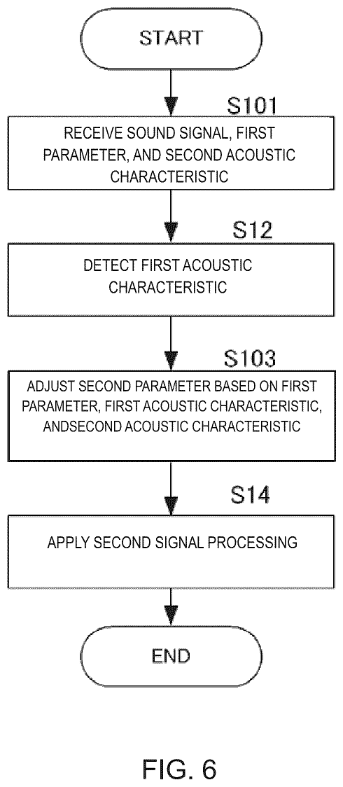

FIG. 6 is a flowchart showing an operation of the sound signal processing device 10A according to the first modified example. The receiver of the sound signal processing device 10A receives a plurality of sound signals from the distribution device 10, the respective first parameters, and the second acoustic characteristic (S101). The first parameter is, for example, a parameter that an audio mixer operator at a live music venue adjusts for the main speaker of the live music venue. Alternatively, the first parameter can be a parameter that an audio mixer operator adjusts for the purpose of distribution, separately from that for the main speaker of the live music venue. In that case, the audio mixer operator adjusts the parameter on the basis of sound heard through headphones, which is separate from the sound of the venue.

The detector of the sound signal processing device 10A detects the first acoustic characteristic indicating the reproduction environment of the room (S12). The processor of the sound signal processing device 10A adjusts the second parameter of the second signal processing on the basis of the first parameter and the second acoustic characteristic that have been received, and the first acoustic characteristic that has been detected (S103). The processor of the sound signal processing device 10A further applies the second signal processing to the sound signal that has been received on the basis of the adjusted second parameter (S14). By applying the second signal processing on the sound signal based on the second parameter, a sound signal to be reproduced (reproduction sound signal) in the reproduction environment of the room is obtained.

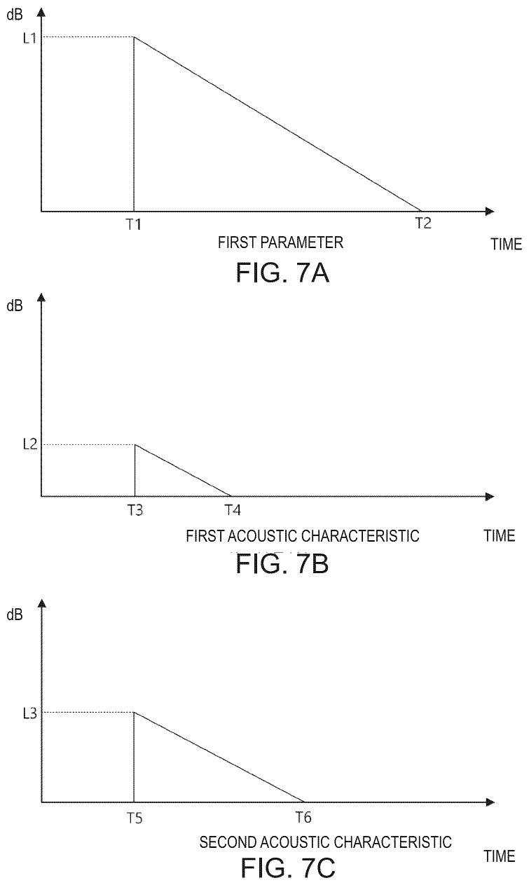

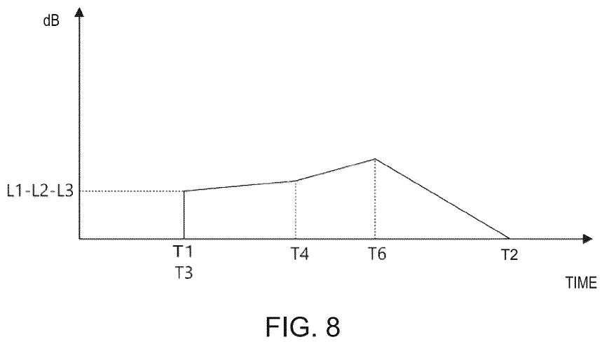

FIG. 7A is a diagram showing, as an envelope curve on a time axis, the reverb effect of the first signal processing intended by the distributor. FIG. 7B is a diagram showing the first acoustic characteristic of the reproduction environment as an envelope curve on the time axis. FIG. 7C is a diagram showing the second acoustic characteristic of the distribution source as an envelope curve on the time axis. FIG. 8 is a diagram showing the reverb effect of the second signal processing as an envelope curve on the time axis. In FIGS. 7A-8, the vertical axis represents the sound pressure (dB) of the impulse response, and the horizontal axis represents the time.

The processor of the sound signal processing device 10A calculates the impulse response of the reverb process from the first parameter, and calculates the envelope (FIG. 7A) of said impulse response. The processor of the sound signal processing device 10A measures the impulse response of the room, and calculates the envelope (FIG. 7B) of said impulse response. The processor of the sound signal processing device 10A calculates the envelope (FIG. 7C) of the impulse response of the second acoustic characteristic received from the distribution device 10. The processor of the sound signal processing device 10A subtracts the envelope (FIG. 7B) of the impulse response of the room and the envelope (FIG. 7C) of the impulse response of the second acoustic characteristic from the envelope (FIG. 7A) of the first parameter, to calculate the envelope (FIG. 8) of the difference. The processor of the sound signal processing device 10A adjusts the second parameter such that the impulse response of the reverb process approximates the envelope (FIG. 8) of this difference. The calculation of the difference of the impulse response can be carried out in the frequency domain. For example, as shown in FIG. 7C, the environment of the venue of the distribution source displays an acoustic characteristic in which a reverberation sound of level L3 generated at time T5 (which coincides with time T1 in this example.) decays until time T6. Thus, the processor of the sound signal processing device 10A calculates a second parameter of the reverb effect obtained by subtracting (or dividing) the level of the reverberation sound generated in the distribution source and the reproduction environment from the first parameter of the first signal processing, from time T1 to time T4, as shown in FIG. 8. The processor of the sound signal processing device 10A calculates the second parameter of the reverb effect obtained by subtracting (or dividing) the level of the reverberation sound generated in the reproduction environment from the first parameter of the first signal processing, from time T4 to time T6.

In this case, the sound signal processing device 10A is able to allow the listener to listen to a sound to which has been added an effect that is close to the distributor's intention and on which the acoustic environment of the venue on the distribution side has been reflected.

### Second Modified Example

The listener can set a reverb effect having a given acoustic characteristic. For example, the sound signal processing device 10A receives fine adjustments of the parameter of the reverb via a GUI including the display unit 101 and the user I/F 102. The sound signal processing device 10A receives, from the listener, a third parameter for adjusting the acoustic characteristic.

Then, the second parameter of the second signal processing to be applied to the sound signal is adjusted on the basis of the first parameter received from the distribution device 10, the first acoustic characteristic of the reproduction environment detected through measurement, etc., and the third parameter that has been received.

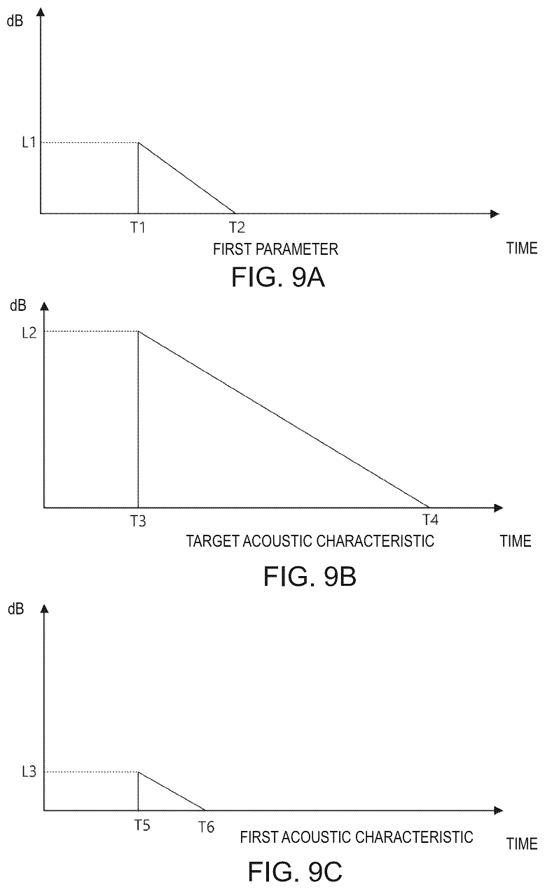

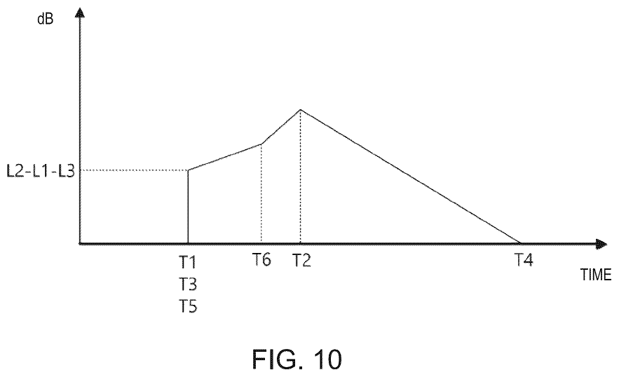

FIG. 9A is a diagram showing, as an envelope curve on a time axis, the first parameter of the reverb effect of the first signal processing intended by the distributor. FIG. 9B is a diagram showing a target acoustic characteristic as an envelope curve on the time axis. FIG. 9C is a diagram showing the first acoustic characteristic of the reproduction environment as an envelope curve on the time axis. FIG. 10 is a diagram showing the second parameter of the second signal processing as an envelope curve on the time axis. In FIGS. 9A-10, the vertical axis represents the sound pressure (dB) of the impulse response, and the horizontal axis represents the time.

The processor of the sound signal processing device 10A calculates the impulse response of the reverb process from the first parameter, and calculates the envelope (FIG. 9A) of said impulse response. The processor of the sound signal processing device 10A calculates the envelope (FIG. 9B) of the impulse response of the reverb process from the third parameter of the target acoustic characteristic. The processor of the sound signal processing device 10A measures the impulse response of the room, and calculates the envelope (FIG. 9C) of said impulse response. The processor of the sound signal processing device 10A subtracts the envelope (FIG. 9A) of the impulse response of the first parameter and the envelope (FIG. 9C) of the impulse response of the room from the envelope (FIG. 9B) of the impulse response of the third parameter, to calculate the envelope (FIG. 10) of the difference. The processor of the sound signal processing device 10A adjusts the second parameter such that the impulse response of the reverb process approximates the envelope (FIG. 10) of this difference. The calculation of the difference of the impulse response can be carried out in the frequency domain. For example, the processor of the sound signal processing device 10A calculates a second parameter of the reverb effect obtained by subtracting (or dividing) the level of the first acoustic characteristic and the first parameter from the third parameter of the target acoustic characteristic, from time T1 to time T6, as shown in FIG. 10. In addition, the processor of the sound signal processing device 10A calculates the second parameter of the reverb effect obtained by subtracting (or dividing) the level of the first parameter from the third parameter of the target acoustic characteristic, from time T6 to time T2.

In this case, the sound signal processing device 10A adjusts the third parameter of the reverb effect in consideration of the distributor's intention, the first acoustic characteristic of the reproduction environment, and the preference of the listener, so it is possible to allow the listener to listen to a sound to which has been added a reverb effect that is close to the distributor's intention and on which the listener's preference has been reflected.

The description of the present embodiment is exemplary in all respects and should not be considered restrictive. The scope of this disclosure is indicated by the Claims section, not the embodiment described above. Furthermore, the scope of this disclosure includes the scope that is equivalent that of the Claims.

For example, in the embodiment described above, an effect for adding reverberation sound was presented as an example of the first signal processing and the second signal processing, but the first signal processing and the second signal processing can be other spatial effects, such as delay or chorus.

What is claimed is:

1. A sound signal processing method comprising:
receiving, from a distribution source, a sound signal, and a first parameter of a first signal processing to be applied to the sound signal;
detecting a first acoustic characteristic of a listener's reproduction environment;
adjusting a second parameter based on the first parameter and the first acoustic characteristic; and
applying a second signal processing on the sound signal based on the second parameter, thereby obtaining a reproduction sound signal to be reproduced in the reproduction environment.

2. The sound signal processing method according to claim 1, further comprising receiving a second acoustic characteristic of a venue environment of the distribution source, wherein
the second parameter is adjusted based on the first parameter, the first acoustic characteristic, and the second acoustic characteristic.

3. The sound signal processing method according to claim 1, wherein
the first signal processing and the second signal processing include a process of adding reverb to the sound signal.

4. The sound signal processing method according to claim 1, wherein
the sound signal is each of a plurality of sound signals corresponding to sounds from a plurality of sound sources,
the first parameter is each of a plurality of first parameters corresponding to the plurality of sound sources, and
control of the second signal processing is carried out individually for each of the plurality of sound signals in accordance with the plurality of first parameters.

5. The sound signal processing method according to claim 1, wherein
the sound signal that has been received is a sound signal before the first signal processing is applied.

6. The sound signal processing method according to claim 5, further comprising
acquiring, from a listener, a third parameter for adjusting an acoustic characteristic, and
the second parameter is adjusted based on the first parameter, the first acoustic characteristic, and the third parameter.

7. A sound signal processing device comprising:
a receiver configured to receive, from a distribution source, a sound signal, and a first parameter of a first signal processing to be applied to the sound signal;
a detector configured to detect a first acoustic characteristic of a listener's reproduction environment; and
a processor configured to adjust a second parameter based on the first parameter and the first acoustic characteristic, and apply a second signal processing on the sound signal based on the second parameter, thereby obtaining a reproduction sound signal to be reproduced in the reproduction environment.

8. The sound signal processing method according to claim 7, wherein
the receiver is further configured to receive a second acoustic characteristic of a venue environment of the distribution source, and
the processor is configured to adjust the second parameter based on the first parameter, the first acoustic characteristic, and the second acoustic characteristic.

9. The sound signal processing device according to claim 7, wherein
the first signal processing and the second signal processing include a process of adding reverb to the sound signal.

10. The sound signal processing device according to claim 7, wherein
the sound signal is each of a plurality of sound signals corresponding to sounds from a plurality of sound sources,
the first parameter is each of a plurality of first parameters corresponding to the plurality of sound sources, and
the processor is configured to control the second signal processing individually for each of the plurality of sound signals in accordance with the plurality of first parameters.

11. The sound signal processing device according to claim 7, wherein
the sound signal is a sound signal before the first signal processing is applied.

12. The sound signal processing device according to claim 11, further comprising
an interface configured to receive, from a listener, a third parameter for adjusting an acoustic characteristic, wherein
the processor is configured to adjust the second parameter based on the first parameter, the first acoustic characteristic, and the third parameter.

13. A sound signal distribution system comprising:
the sound signal processing device according to claim 7; and
a distribution device configured to distribute the sound signal and the first parameter.
